(19) United States
(12) Patent Application Publication
(10) Pub. No.: US 2012/0039566 A1
(43) Pub. Date: Feb. 16, 2012

(54) POLARISATION ROTATOR WITH MULTIPLE BOWTIE-SHAPED SECTIONS

(76) Inventors: Jorge Alfonso Ruiz Cruz, Alpedrete (ES); José Ramón Montejo Garai, Madrid (ES); Jesús María Rebollar Machain, Madrid (ES)

(21) Appl. No.: 13/265,996

(22) PCT Filed: Feb. 16, 2010
(86) PCT No.: PCT/ES2010/070082

§ 371 Date: Oct. 24, 2011

(51) Int. Cl. G02B 6/26

(52) U.S. Cl. 385/28

(57) ABSTRACT

Polarisation rotator by β° between an input and an output waveguide formed by interposing between the input and output waveguides at least to parallepiped-shaped sections in which a bowtie-shaped cut-out has been made, presenting two axes of symmetry, one along a longitudinal axis and another along a transverse axis, that is defined by a series of precise constructive parameters and has its longitudinal axis at an angle with respect to the axis of one of the input and output waveguides, wherein the sections are constructively identical by twos.

### CROSS-REFERENCE TO RELATED APPLICATIONS

This application is a National Stage of International Application No. PCT/ES2010/070082 filed Feb. 16, 2010. This application claims the benefit and priority of Spanish Application No. 200801054, filed Apr. 14, 2008. The entire disclosure of each of the above applications is incorporated herein by reference.

### OBJECT OF THE INVENTION

The object of the invention is a polarisation rotator for electromagnetic waves presenting a plurality of sections, all of which having a bowtie shape, each bowtie-shaped section being rotated with respect to the adjacent section.

The present invention is characterised by a special configuration and design of the bowtie-shaped section of each bowtie, as well as the rotation angle of each section in order to obtain a polarisation rotator that has a maximum compactness, minimum length and an adaptation of the electromagnetic wave better than that hitherto obtained.

Therefore, the present invention lies in the field of polarisation rotators for waveguides.

### BACKGROUND OF THE INVENTION

There are numerous efforts for obtaining polarisation rotators for electromagnetic waves.

Some, such as those commercialised by the FLANN company™, are rotators manufactured from waveguides that have been twisted in a precise manner, while maintaining the dimensions of the waveguide. This way of obtaining polarisation rotators has several drawbacks. On one hand, there are drawbacks related to the manufacturing process, as the waveguide must be subjected to high temperatures in order to twist it, which generates stresses in the material requiring to analyse the material again. On another hand, the rotator dimensions cannot be reduced.

An analysis of rotation by twisting a waveguide is made in the paper “An Analysis of a Hybrid-Mode in a Twisted Rectangular Waveguide” (Hatsuo Yabe, Yasuto Mushiake) published in IEEE Transactions on Microwave Theory and Techniques, Vol. MTT-32, no. 1 Jan. 1984).

Another known solution for rotating the polarisation that avoids the aforementioned drawbacks is described in the paper: “Design of Compact Waveguide Twists” by Pedro I. Alonso-Juaristi, Jaime Esteban and Jesús Maria Rebollar, published in IEEE Transactions on Microwave Theory and Techniques, Vol. 45, no. 5, May 1997. In this paper the polarisation rotator is based on an alternating succession of waveguides with rectangular and circular cross-sections, wherein the rectangular cross-section waveguides are disposed successively rotated to provide the full rotation. Although it does manage to prevent some of the drawbacks mentioned for the first solution proposed, it does not solve the problem of compactness, and the manufacturing procedure is not at all favourable.

The paper “Full Wave Design of Broad-Band Compact Waveguide Step-Twists” (Massimo Baralis, Ricardo Tascone, Oscar Antonio Peverini, Giusseppe Virone, Renato Orta) published in IEEE Microwave and Wireless Components Letters, Vol. 15, no. 2, February 2005, describes a polarisation rotator consisting of a succession of sections or elements that have a rectangular cross-section, with the sections being rotated with respect to their adjacent sections. Although certain compactness is achieved, it does not manage an adaptation better than 40 dB in the entire useful band of the guide.

Another solution known in the state of the art is U.S. Pat. No. 6,879,221 B1, which describes a polarisation rotator in which both waveguides are disposed orthogonally to a transformer and are coupled in the transformer by a smaller section. This proposed solution, in addition to not being compact, is only valid for orthogonal twist rotations, and the adaptation results obtained has a very small bandwidth compared to the present invention.

The paper “Polarization Rotator—Analysis and Design” (Rafal Lech, Jerzy Mazur) was published in the 14th Conference on Microwave Techniques, 2008. COMITE 2008. April 2008. This paper describes a new analysis of a polariser composed of frequency-selective surface sections. The analysis is made by considering the polariser as a connection in cascade of several elementary layers composed of linear periodic matrices of metallic wires.

Finally, the paper “Compact 90° Twist formed by a Double-Corner-cut Square Waveguide Section” (Anatoliy, Kirilenko, Dimitriy Y. Kulik, and Leonid A. Rud) published in IEEE Transactions on Microwave Theory and Techniques, Vol. 56, no. 7 July 2008, shows a rectangular waveguide rotator in which the section in charge of the rotation is formed by a square section having two cuts in two of its square corners. Although certain compactness is achieved, only a 90° rotation is achieved and the adaptation is no better than that obtained hitherto.

The following documents considered to be closely related to the object of the invention are also known:

On one hand, document GB 2429119 describing a polarisaton rotator presenting several bowtie-shaped sections, which among other embodiments describes one for a 45° rotator that requires disposing four consecutive sections, to achieve an adaptation of 40 dB. However, if only two sections are used the adaptation obtained is 25 dB. To achieve instead a rotation from 60° to 90°, the initial geometry is not maintained and it is necessary to make adjustments.

Also known is document CA 2320667 A1, which discloses a polarisation rotator that uses sections with bowtie-shaped cut-outs, characterised in that all the arcs have the same radius. Although these embodiments obtain an adaptation level ranging from 23 dB (FIG. 4) to 27 dB, the compactness achieved with the embodiment proposed is not very good; that is, these results are achieved with relatively large thicknesses, more than twice than that of our specific bowtie shape.

Another document that is part of the state of the art is U.S. Pat. No. 6,995,628 B2, in which the cut-out made in the rotator sections presents a series of straight segments, achieving for a rotation angle of 90° and a single section a

Finally, document U.S. Pat. No. 3,651,435 A1, describes a gradual polarisation rotator formed by a succession of consecutive sections that bear no relation to the shape of the cut-outs of the sections proposed herein.

Therefore, having discussed the different polarisation rotators known to date, the object of the present invention is to provide a polarisation rotator which improves the adaptation by 40 dB in the entire useful band of the guide, with a maximum compactness, minimum length in the longitudinal sense, small mass and volume and being very easy to manufacture.

### DESCRIPTION OF THE INVENTION

The object of the polarisation rotator invention, as stated above, is a rotator allowing an adaptation better than 40 dB in the entire useful band of the guide, with a maximum compactness and minimum length in the longitudinal sense.

In addition to the aforementioned objectives, the rotator is intended to be compact in the transverse sense, not exceeding the conventional flanges, easy to machine and sturdy, easily integrated in complex subsystems such as Orthomodes, E-H mixed elbows and routing structures, to allow an inexpensive manufacture with a very high repetitiveness, with a low mass and volume, flexibility in the choice of the number of sections to comply with the specifications of either adaptation or bandwidth, with a rotation degree that can be greater or less than 90° as desired, and in which the rotator is not exclusively limited to rectangular waveguide sections identical at the input and output, so that the waveguide sections can be different at the input and output.

To achieve these objectives a polarisation rotator is proposed with multiple sections, each section having a bowtie-shaped cut-out with a precise geometry.

Each bowtie cut-out made in each section has two planes of symmetry, one along a longitudinal axis that runs along the greater dimension of the bowtie, and a transverse plane of symmetry that runs along an axis transverse to the aforementioned one. Each bowtie cut-out is defined by certain parameters that allow an accurate construction of the cut-outs.

The rotator can be formed by a variable number of sections, all of which have a bowtie cut-out with the same geometrical shape, this is, the same constructive parameters.

The longitudinal axis of each bowtie cut-out of each section is at an angle to the axis of the input and output waveguides.

Thus, to obtain a 90° rotator having two sections with the corresponding bowtie cut-outs, the two cut-outs will have the same constructive properties and the longitudinal axis of each cut-out will be at an angle φ with respect to the axis of the input and output waveguide respectively, these axes logically being perpendicular as a 90° rotator is sought.

If three sections are used to obtain a 90° rotator, the two bowtie cut-outs of the end sections will have the same parameters and their longitudinal axes will be at an angle φ to the axis of the input and output waveguides, while the bowtie cut-out of the central section will have its own constructive parameters and be at an angle of 45° to either axis of the input and output waveguides, as it is a 90° rotator.

Thus, to unify the parameters that must be considered when designing a 90° rotator formed by N sections, the constructive identities and rotation of the bowtie cut-outs shall be as follows:

If the rotator has an even number of sections with bowtie cut-outs:

Raᵢ=Ra_{(N-i+}1)
Rbᵢ=Rb_{(N-i+}1)
Laᵢ=La_{(N-i+}1)
Lbᵢ=Lb_{(N-i+}1)
Lcᵢ=Lc_{(N-i}+1)
Eᵢ=E_{(N-i+}1)
where i=1, 2, . . . , N/2
And all of the bowtie cut-outs have their longitudinal axis at an angle φᵢ with respect to one of the axes of the input and output waveguides.

Therefore, the number of parameters needed to define a rotator formed by N sections, where N is an even number, is 7*N/2.

If the rotator has an odd number of sections with bowtie cut-outs:

Raᵢ=Ra_{(N-i+}1)
Rbᵢ=Rb_{(N-i+}1)
Laᵢ=La_{(N-i+}1)
Lbᵢ=Lb_{(N-i+}1)
Lcᵢ=Lc_{(N-i+}1)
Eᵢ=E_{(N-i+}1)
where i=1, 2, . . . , (N−1)/2

And all of the bowtie cut-outs have their longitudinal axis at an angle φᵢ with respect to one of the axes of the input and output waveguides.

However, the bowtie cut-out of section (N+1)/2 has the following parameters:

### Ra_{(N+}1)/2

### Rb_{(N+}1)/2

### La_{(N+}1)/2

### Lb_{(N+}1)/2

### Lc_{(N+}1)/2

### E_{(N+}1)/2

And it is rotated 45° with respect to either axis of the input and output waveguides, as a 90° rotation is sought.

Therefore, the number of parameters needed to define a rotator formed by N sections, where N is an odd number, is 7*[(N+1)/2]−1.

The consecutive arrangement of several sections with bowtie cut-outs allows obtaining rotators not only of 90° but also of any angle β between the input and output.

If the rotator is formed by two sections with bowtie-shaped cut-outs, both cut-outs will have the same constructive parameters Ra, Rb, La, Lb, Lc, E and are rotated by an angle φ to the axes of the input and output waveguides, respectively.

If the rotator has three sections with bowtie cut-outs, the parameters of the bowtie cut-outs of the end sections will have the same constructive parameters, Ra, Rb, La, Lb, Lc, E, each one being rotated an angle j with respect to the axes of the input and output waveguide respectively, while the cut-out of the central section will have its own parameters and be rotated by half the intended rotation, or b/2, with respect to either axis of the input and output waveguide.

The generalisation for rotators of β° formed by N sections, depending on whether N is odd or even, is identical to that shown above except that instead of using angles φᵢ and 45° for the central section when N is odd, angles βᵢ and additionally β/2 will be used for the central section when N is odd.

### DESCRIPTION OF THE DRAWINGS

To complete the description made below and to aid a better understanding of its characteristics, the present descriptive memory is accompanied by a set of drawings, the figures of which represent the most significant details of the invention for purposes of illustration only and in a non-limiting sense.

FIGS. 1, 2 and 3 represent a 90° rotator formed by a single section, where FIG. 1 is a perspective view, FIG. 2 is a front view and FIG. 3 is a representation of the relationship of the bowtie cut-out to the waveguides.

FIG. 4 shows a perspective view of a cross section with a bowtie-shaped cut-out.

FIGS. 5 and 5a show a plan view of the bowtie-shaped cut-outs indicating the necessary constructive parameters.

FIGS. 6, 7 and 8 represent a 90° rotator formed by two sections, where FIG. 1 is a perspective view, FIG. 2 is a front view and FIG. 3 is a representation of the relationship of the bowtie cut-out to the waveguides.

FIGS. 9 and 10 show a perspective view of the two grouped sections and a plan view showing in detail the relationship of one of the bowtie cut-outs to the other.

FIGS. 11, 12 and 13 show a 90° rotator formed by three sections with corresponding bowtie cut-outs.

FIG. 14 shows a plan view of the three sections showing how the cut-outs are disposed with respect to each other.

FIGS. 15, 16 and 17 show a β° rotator formed by two sections with corresponding bowtie cut-outs.

FIG. 18 shows a detailed view of the angle formed by the longitudinal axes of the bowtie cut-outs with respect to the axes of the input and output waveguides in the case of β° rotator with two sections.

FIGS. 19, 20 and 21 show a β° rotator formed by three sections with their corresponding bowtie cut-outs.

FIG. 22 shows the angle formed by the longitudinal axes of the bowtie cut-outs with respect to the axes of the input and output waveguides in the case of a β° rotator with three sections.

FIGS. 23 and 24 show a perspective view and a plan view of a section of those used in the polarisation rotator, showing a series of orifices for alignment and attachment.

FIGS. 25 and 26 show a perspective view and a plan view of an assembly with two grouped sections.

FIGS. 27 and 28 show the results obtained when using a single section and β=90°, or using two sections and β=90° respectively.

### PREFERRED EMBODIMENT OF THE INVENTION

In view of the figures, a preferred embodiment of the proposed invention is described below.

The invention of a polarisation rotator with several bowtie-shaped sections, as described, consists in the adjacent disposition of at least two parallelepiped sections of a certain thickness in which cut-outs have been made in accordance with certain constructive parameters, the longitudinal axis of each bowtie cut-out being at a specific angle of inclination with respect to the axes of the input and output waveguides.

Thus, FIG. 4 shows the constructive form of a section (1) which, as stated above, has a parallelepiped configuration with a bowtie-shaped cut-out (2).

Said cut-out (2) has two axes of symmetry, one with respect to a plane that crosses a longitudinal axis (4) along the greater dimension of said cut-out, and another plane of symmetry that crosses an axis (5) that is transverse to the other one. The shape of the cut-out (2) is described as a bowtie, this being a non-limiting approximation that is only meant as a way of identifying the shape it resembles. This cut-out (2) can be defined in terms of two rhombuses or lobes aligned on one of their vertices or ends, these vertices or ends being disposed such that they are superimposed.

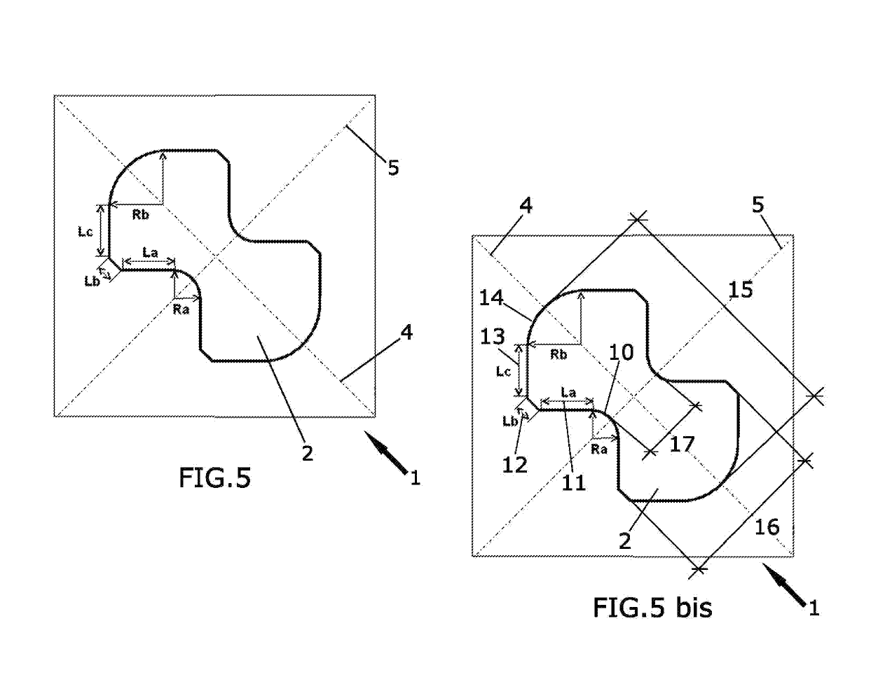

FIG. 5 shows the parameters used to construct the cut-outs (2), which include the parameters Ra, Rb, La, Lb, Lc and the thickness E.

FIG. 5a shows that the bowtie indeed has two axes of symmetry, so that defining only one fourth of the bowtie is sufficient to determine all of it.

The exact shape of the bowtie with which the claimed results are achieved is as follows:

a first arc of circle of 45° (10) with radius Ra and its centre outside the bowtie, thereby defining a concave arc as seen from outside the bowtie cut-out;

a second straight segment (11) with length La;

a third inclined segment (12) at 45° with respect to the horizontal and length Lb;

a fourth straight segment (13) rotated 45° with respect to the previous straight segment with length Lc;

a final arc of circle of 45° (14) with radius Rb and its center inside the bowtie, defining a convex arc as seen from the outside.

Another parameter that can be used to define the sections with bowtie-shaped cut-outs is the thickness E of the sections, which has a value of 0.1 to 0.3 times the width of the rectangular waveguide.

To allow defining the exact shape of the bowtie in a precise manner in order to achieve the ends sought, with a high coefficient of reflection, compactness and reduced thickness. Once the values have been selected they must fulfil the following constraints:

A maximum distance (15) between the arcs of radius Rb given by:

Xmax=(Ra+La+Lc)*sqrt (2)+2*Lb+2*Rb (1−(sqrt(2)/2))

and a value from 1.4 to 1.7 times the width of the input and output rectangular waveguide.

A maximum distance (16) between the segments of length Lb given by:

Ymax=(Rb+Lc)*sqrt (2)

and a value from 0.8 to 1.1 times the width of the input and output rectangular waveguide.

A minimum distance (17) between the arcs of radius Ra given by:

Ymin=(Rb+Lc−La)*sqrt (2)−2*Ra (1−(sqrt(2)/2))

and a value from 0.3 to 0.5 times the width of the input and output rectangular waveguide.

The values of the maximum distances (15) and (16) between the segments of radius Ra and Rb respectively define the dimensions of the rectangle in which the bowtie-shaped cut-out is framed.

The specific shape of the bowtie shows significant differences from rotators with cut-outs having a similar approximate shape. Thus, rotators are achieved with reflection coefficients better than 40 dB for, for example, a 90° rotation, the thickness E is significantly reduced and the compactness of the assembly is improved as its length is the minimum possible length.

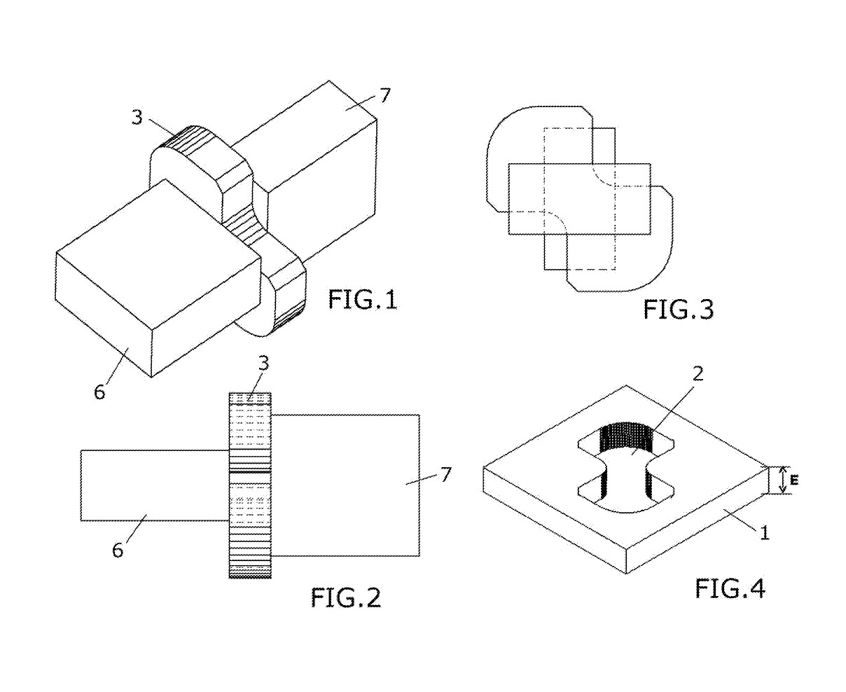

Thus, FIGS. 1 to 3 represent a 90° rotator formed by a single section, representing the contour (3) of the cut-out (2), as for electromagnetic purposes what is essentially relevant is the shape of the contour (3) of the cut-out (2).

Although the embodiment having a single section with a bowtie cut-out can be a possible constructive form, it cannot provide an adaptation better than 40 dB, so that it becomes necessary to use at least two sections adjacent to each other.

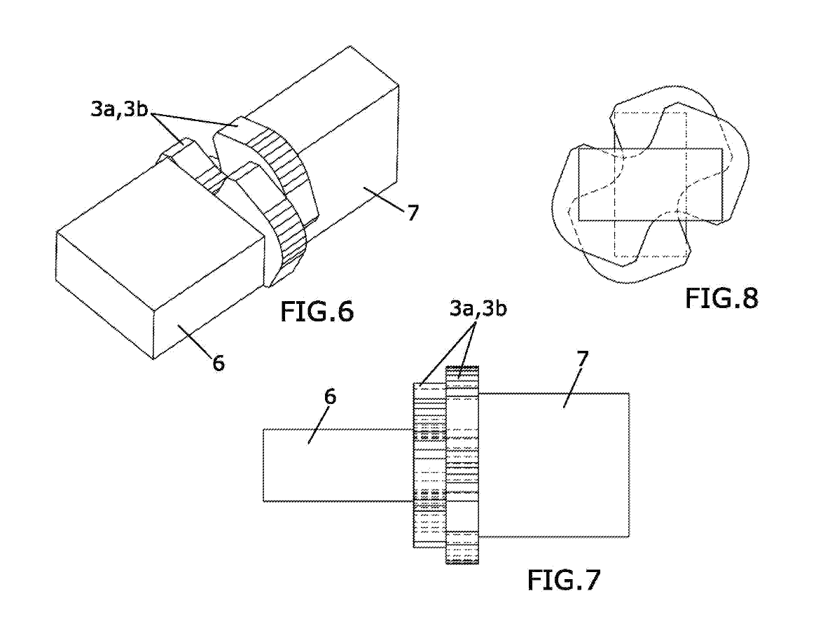

Thus, FIGS. 6, 7 and 8 show a 90° rotator formed by two sections, representing the contours (3a) and (3b) of each cut-out made in each section to view and understand better the effect produced.

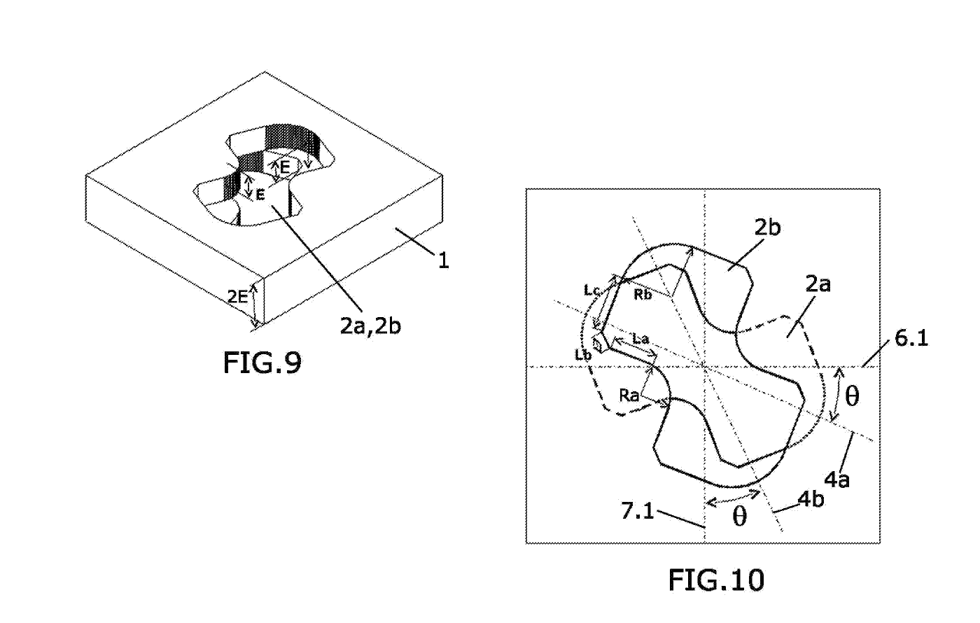

FIG. 9 shows the arrangement of the two sections (1) adjacent to one another by their greater face, each one having their respective cut-outs (2a) and (2b) with a butterfly shape.

FIG. 10 shows how the longitudinal axis (4a) of the cut-out (2a) is at an angle φ with respect to the axis (6.1) of the input waveguide (6), while the cut-out (2b) has a longitudinal axis (4b) at an angle φ with respect to the axis (7.1) of the output waveguide (7).

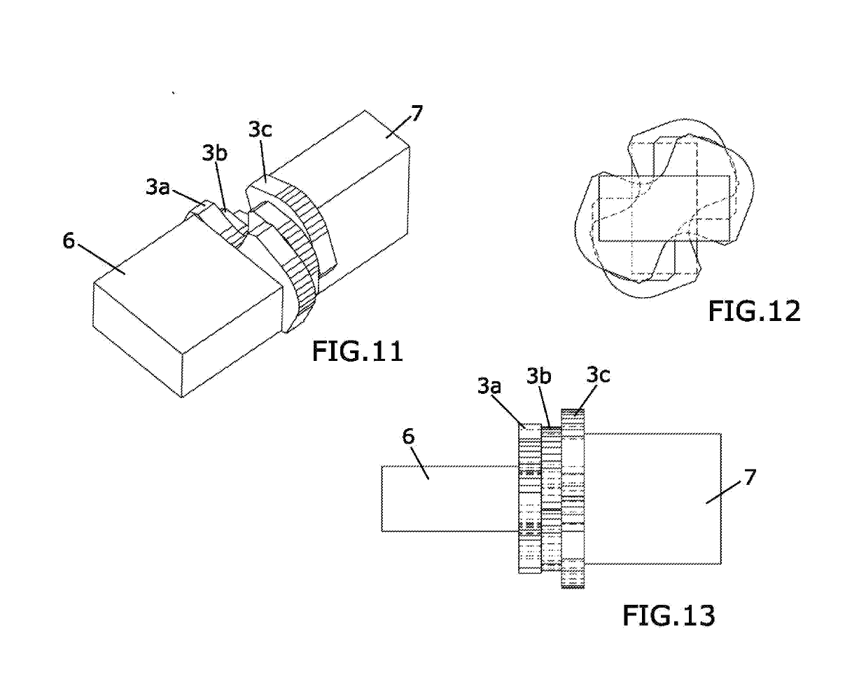

FIGS. 11 to 13 show the construction of a 90° rotator formed by three sections, not shown, representing only the contours (3a), (3b) and (3c) made in each section, each of these cut-outs having certain constructive parameters and an inclination with respect to the axis of the input and output waveguides.

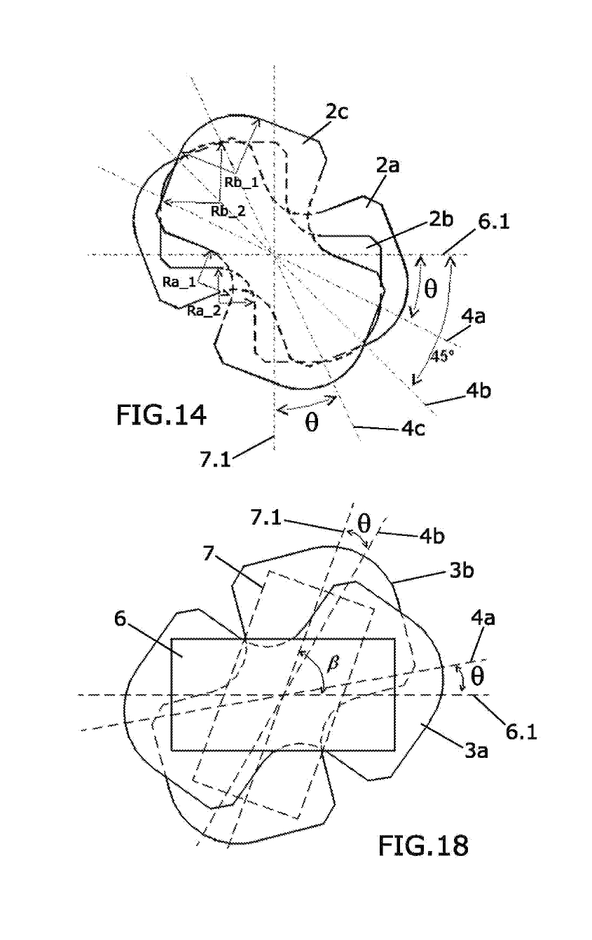

Thus, FIG. 14 shows that the cut-out (2a) has a longitudinal axis (4a) at an angle φ with respect to the axis (6.1) of the input waveguide, while the cut-out (2c) has a longitudinal axis (4c) at an angle φ with respect to the axis (7.1) of the output waveguide, and the cut-out (2b) of the intermediate section has an angle of 45° with respect to either axis of the input and output waveguides (6) or (7), as they are perpendicular to each other.

Therefore, for a rotator formed by three sections the constructive parameters needed will be:

those corresponding to the cut-outs (2a) and (2c) of the end sections, which will be the same parameters, this is:

### Ra₁=Ra₃

### Rb₁=Rb₃

### La₁=La₃

### Lb₁=Lb₃

### Lc₁=Lc₃

### E₁=E₃

Where both cut-outs (2a) and (2c) are rotated by an angle φ with respect to the corresponding axis of the waveguide to which they are attached.

and the parameters corresponding to the cut-out (2b) of the intermediate section, this is: Raₑ, Rb₂, La₂, Lb₂, Lc₂, E₂ forming an angle of 45° to either axis of the input and output waveguides.

To generalise the constructive aspects of a 90° rotator with N sections, analysing the constructive characteristics of the bowtie shapes of the sections and the total number of parameters needed for their design, it is necessary to differentiate the cases with an even or odd number of sections:

90° rotator with an even number of sections N with bowtie-shaped cut-outs.

Raᵢ=Ra_{(N-i+}1)
Rbᵢ=Rb_{(N-i+}1)
Laᵢ=La_{(N-i+}1)
Lbᵢ=Lb_{(N-i+}1)
Lcᵢ=Lc_{(N-i+}1)
Eᵢ=E_{(N-i+1})
where i=1, 2, . . . , N/2

And all of the bowtie cut-outs have their longitudinal axis at an angle φᵢ with respect to one of the axes of the input and output waveguides.

Therefore, the number of parameters needed to define a rotator formed by N sections, where N is an even number, is 7*N/2.

90° rotator with an odd number of sections N with bowtie shaped cut-outs.

Raᵢ=Ra_{(N-i+}1)
Rbᵢ=Rb_{(N-i+}1)
Laᵢ=La_{(N-i+}1)
Lbᵢ=Lb_{(N-i+}1)
Lcᵢ=Lc_{(N-i+}1)
Eᵢ=E_{(N-i+}1)
where i=1, 2, . . . , (N−1)/2
And all of the bowtie cut-outs have their longitudinal axis at an angle φᵢ with respect to one of the axes of the input and output waveguides.

However, the bowtie cut-out of section (N+1)/2 has the following parameters:

### Ra_{(N+}1)/2

### Rb_{(N+}1)/2

### La_{(N+}1)/2

### Lb_{(N+}1)/2

### Lc_{(N+}1)/2

### E_{(N+}1)/2

And it is rotated 45° with respect to either axis of the input and output waveguides, as a 90° rotation is sought.

Therefore, the number of parameters needed to define a rotator formed by N sections, where N is an odd number, is 7*[(N+1)/2]−1.

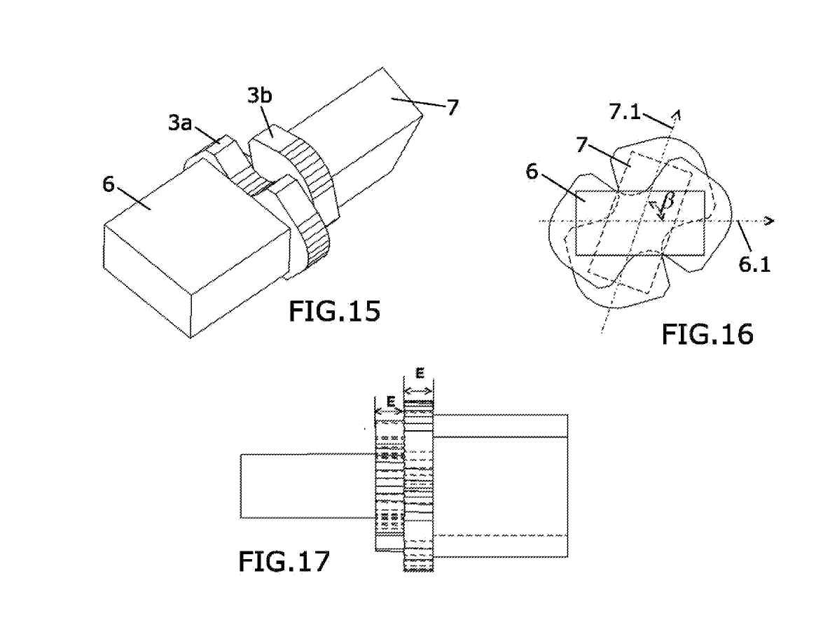

FIGS. 15, 16 and 17 show a β° rotator formed by two sections interposed between the input waveguide (6) and the output waveguide (7). This is, the axes (6.1) and (7.1) of the input waveguide (6) and output waveguide (7) are at an angle of β° to each other. The three figures show the contours (3a) and (3b) of the corresponding cut-outs of the sections.

FIG. 18 shows the arrangement of the contours (3a) and (3b) with respect to the input and output waveguides (6) and (7) respectively. Thus, the first contour (3a) has a longitudinal axis (4a) at an angle φ to the axis (6.1) of the waveguide (6), while the contour (3b) has a longitudinal axis (4b) at an angle β° to the axis (7.1) of the waveguide (7), the two axes (6.1) and (7.1) being at an angle β° to each other. The constructive parameters of the cut-outs are identical, this is, it is only necessary to define Ra, Rb, La, Lb, Lc and E, and the angle φ.

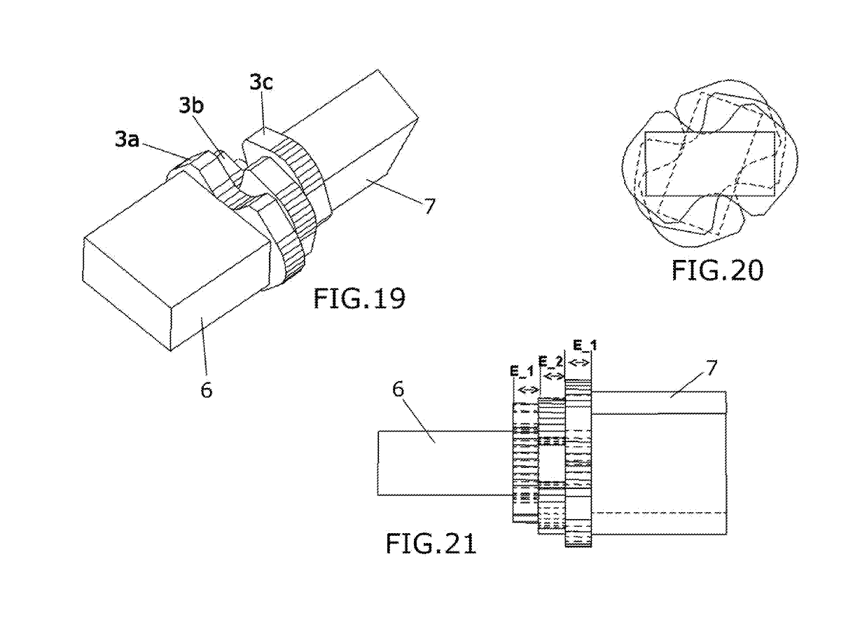

FIGS. 19, 20 and 21 show the constructive characteristics of a rotator of β° formed by three sections with bowtie-shaped cut-outs, representing only the contours (3a), (3b) and (3c) of the corresponding cut-outs, showing their disposition with respect to the input and output waveguides.

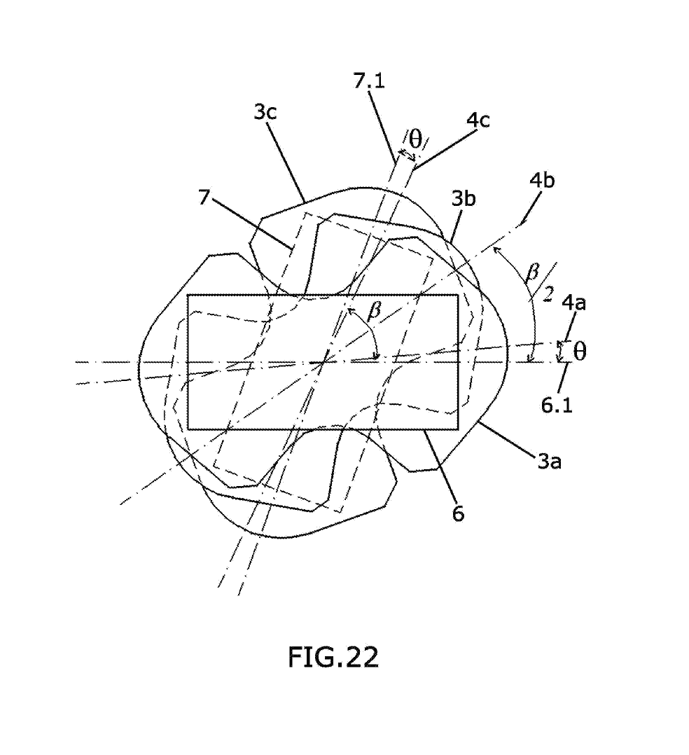

FIG. 22 shows the resulting disposition of these contours. Thus, contour (3a) has a longitudinal axis (4a) at an angle φ with respect to the axis (6.1) of the input waveguide (6), while the contour (3c) corresponding to the other end section adjoining the waveguide (7) also has a longitudinal axis (4c) at an angle φ to the axis (7.1) of the output waveguide (7). Finally, contour (3b) of the cut-out of the intermediate section is at an angle β/2 with respect to either axis (6.1), (7.1) of the input and output waveguides.

Thus, in the case of a rotator of β° formed by three sections, the parameters needed to define it are:

### Ra₁=Ra₃

### Rb₁=Rb₃

### La₁=La₃

### Lb₁=Lb₃

### Lc₁=Lc₃

### E₁=E₃

where the two cut-outs are rotated by an angle φ with respect to the corresponding axis of the waveguide to which they are attached.

and the parameters corresponding to the cut-out (2b) of the intermediate section, this is: Ra₂, Rb₂, La₂, Lb₂, Lc₂, E₂ forming an angle of β/2 to either axis of the input and output waveguides.

The generalisation for rotators of β° formed by N sections, depending on whether N is odd or even, is identical to that shown above except that instead of using angles φᵢ and 45° for the central section when N is odd, angles βᵢ and additionally β/2 will be used for the central section when N is odd.

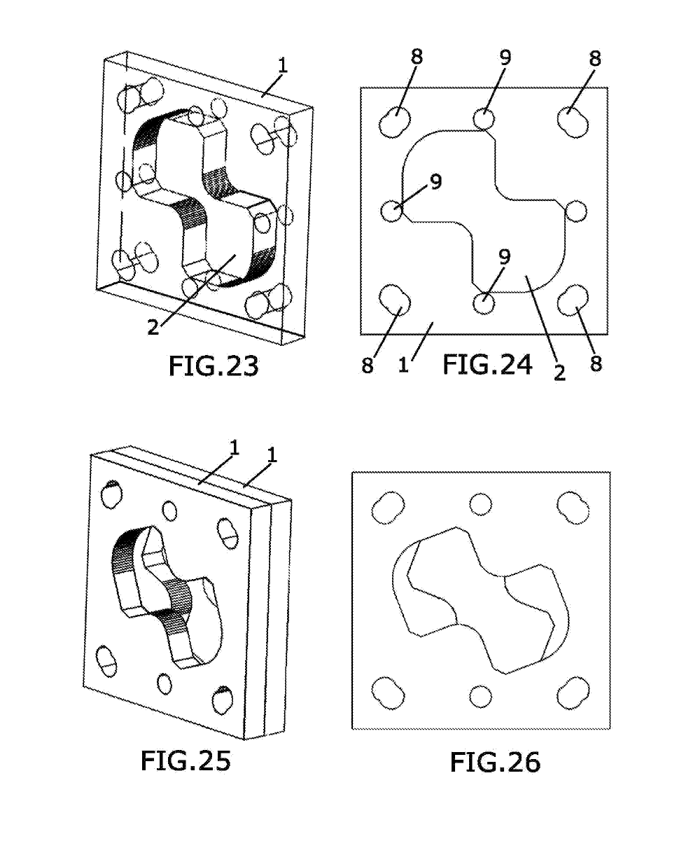

FIGS. 23 to 26 show that the sections (1) have, in addition to the bowtie cut-outs (2a), a series of orifices such that the four oblong orifices (8) of the vertices are meant for applying attachment screws, while the orifices (9) are meant to facilitate the alignment of the sections.

Thus, the specific and concrete shape of the bowtie-shaped cut-outs of the rotator sections result in rotators having a reflection coefficient better than 40 dB in teh case with two sections and an angle β=90°, a reduced thickness E of the sections and therefore an improved overall compactness of the rotator.

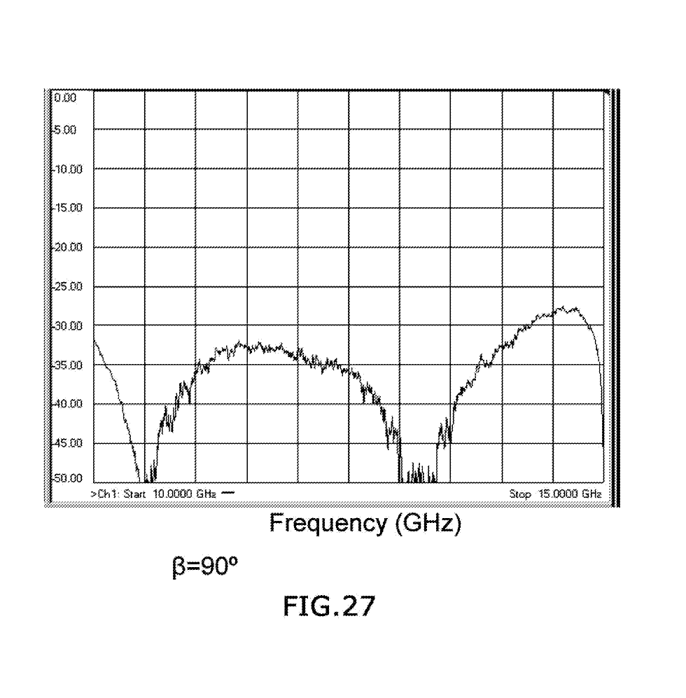

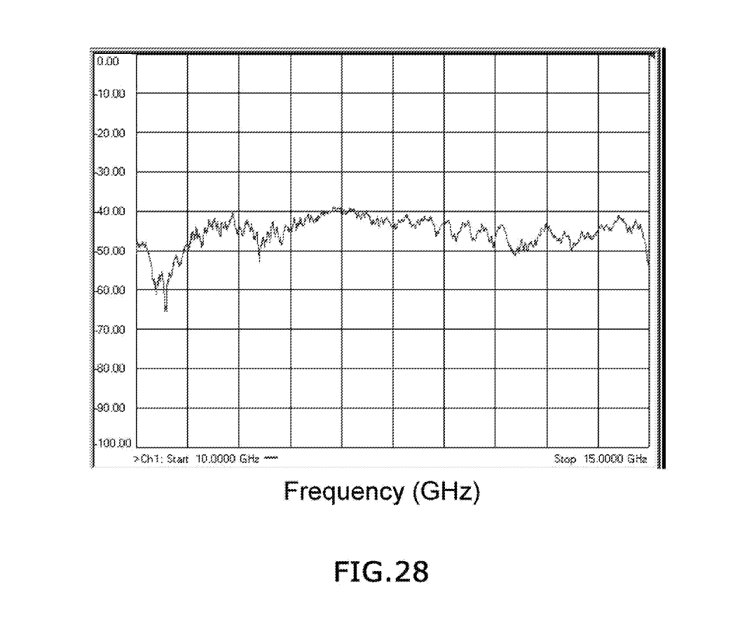

Thus, FIG. 27 shows the coefficients of reflection in dB as a function of frequency in the case using a single section and β=90°, while FIG. 28 shows the coefficients of reflection in dB as a function of frequency in the case using a single section and β=90°, where it is worth noting that the coefficient of reflection exceeds 40 dB in the entire useful bandwidth of the guide.

The essence of this invention is not affected by variations in the materials, shape, size and arrangement of its component elements, described in a non-limiting manner that will allow its reproduction by an expert.

1. Polarisation rotator between an input waveguide and an output waveguide with their corresponding axes being at an angle of β° to each other, interposing between the input and output waveguides at least two parallelepiped-shaped sections, each of these having some bowtie-shaped cut-outs, wherein the bowtie-shaped cut-outs of the sections have two planes of symmetry, one along a longitudinal axis that runs along the greater dimension of the bowtie, and another transverse plane of symmetry that runs along an axis transverse to the aforementioned axis, wherein each bowtie-shaped cut-out is defined by a series of parameters that allow a precise construction of these cut-outs, namely Ra, Rb, La, Lb, Lc, y E, and their longitudinal axis is inclined at an angle to the axis of one of the waveguides, where the cut-out has:
a first arc of circle of 45° (10) with radius Ra and its centre outside the bowtie, thereby defining a concave arc as seen from outside the bowtie cut-out;
a second straight segment (11) with length La;
a third inclined segment (12) at 45° with respect to the horizontal and length Lb;
a fourth straight segment (13) rotated 45° with respect to the previous straight segment with length Lc;
a final arc of circle of 45°(14) with radius Rb and its centre inside the bowtie, defining a convex arc as seen from the outside; and wherein the thickness E of these sections has a value from 0.1 to 0.3 times the width of the rectangular waveguide.

2. The polarisation rotator according to claim 1, wherein the parameters fulfil the following conditions:
a maximum distance (15) between the arcs of radius Rb given by
Xmax=(Ra+La+Lc)*sqrt (2)+2*Lb+2*Rb (1−(sqrt(2)/2))
and a value from 1.4 to 1.7 times the width of the input and output rectangular waveguide;
a maximum distance between the segments of length Lb given by
Ymax=(Rb+Lc)*sqrt (2)
and a value from 0.8 to 1.1 times the width of the input and output rectangular waveguide; and
a minimum distance between the arcs of radius Ra given by
Ymin=(Rb+Lc−La)*sqrt (2)−2*Ra(1−(sqrt(2)/2))
and a value from 0.3 to 0.5 times the width of the input and output rectangular waveguide.

3. The polarisation rotator according to claim 2, wherein the number of sections of the rotator is N, where N is an even number, the parameters that define the bowtie-shaped cut-outs of each section will be:
Raᵢ=Ra_{(N-i+}1)
Rbᵢ=Rb_{(N-i+}1)
Laᵢ=La_{(N-i+}1)
Lbᵢ=Lb_{(N-i+}1)
Lcᵢ=Lc_{(N-i+}1)
Eᵢ=E_{(N-i+}1)
where i=1, 2, . . . , N/2
and wherein all of the bowtie-shaped cut-outs have their longitudinal axis at an angle φᵢ with respect to one of the axes of the input and output waveguides, so that the number of parameters needed to define a rotator formed by N sections, where N is an even number, is 7*N/2.

4. The polarisation rotator according to claim 2, wherein the number of sections (1) of the rotator is N, where N is an odd number, the parameters that define the bowtie-shaped cut-outs of each section will be:
Raᵢ=Ra_{(N-i+}1)
Rbᵢ=Rb_{(N-i+}1)
Laᵢ=La_{(N-i+}1)
Lbᵢ=Lb_{(N-i+}1)
Lcᵢ=Lc_{(N-i+}1)
Eᵢ=E_{(N-i+}1)
where i=1, 2, . . . , (N−1)/2
and all of the bowtie cut-outs have their longitudinal axis at an angle φᵢ with respect to one of the axes of the input and output waveguides, while the bowtie-shaped cut-out of section (N+1)/2 has the following parameters:
Ra_{(N+}1)/2
Rb_{(N+}1)/2
La_{(N+}1)/2
Lb_{(N+}1)/2
Lc_{(N+}1)/2
E_{(N+}1)/2
and it is rotated β/2° with respect to any axis of the input and output waveguides, and wherein the number of parameters needed to define a rotator formed by N sections is an odd number defined by 7*[(N+1)/2]−1.

5. The rotator according to claim 1 wherein the sections that form the rotator have a series of orifices, wherein the four oblong orifices of the vertices are meant for applying attachment screws and the orifices are meant for facilitating the alignment of the sections.
